(19) United States
(12) Patent Application Publication
(10) Pub. No.: US 2023/0336338 A1
(43) Pub. Date: Oct. 19, 2023

(54) OPTICAL TRANSMISSION SYSTEM AND OPTICAL TRANSMISSION METHOD

(71) Applicant: NIPPON TELEGRAPH AND TELEPHONE CORPORATION, Tokyo (JP)

(72) Inventors: Yuto SAGAE, Musashino-shi, Tokyo (JP); Kazuhide NAKAJIMA, Musashino-shi, Tokyo (JP); Taiji SAKAMOTO, Musashino-shi, Tokyo (JP); Nobutomo HANZAWA, Musashino-shi, Tokyo (JP); Takashi MATSUI, Musashino-shi, Tokyo (JP); Noriyuki ARAKI, Musashino-shi, Tokyo (JP); Shinichi AOZASA, Musashino-shi, Tokyo (JP); Ryota IMADA, Musashino-shi, Tokyo (JP); Yoko YAMASHITA, Musashino-shi, Tokyo (JP)

(73) Assignee: NIPPON TELEGRAPH AND TELEPHONE CORPORATION, Tokyo (JP)

(21) Appl. No.: 18/009,399

(22) PCT Filed: Jun. 11, 2020
(86) PCT No.: PCT/JP2020/022961

§ 371 Date: Dec. 9, 2022

(51) Int. Cl. H04L 9/08; H04B 10/25

(52) U.S. Cl. CPC H04L 9/088; H04B 10/25

(57) ABSTRACT

It is an object of the present disclosure to reduce the risk of information exploitation by a malicious third party while allowing communication data to be demodulated in real time. An optical transmission system according to the present disclosure includes a transmitter which transmits an optical signal representing a cryptographic key and an optical signal representing communication data individually, an optical transmission path including a heterogeneous multi-core optical fiber having multiple cores, at least one of which has a different propagation delay time, the optical transmission path transmitting the optical signal representing the cryptographic key using a first core with a smaller delay among the multiple cores and the optical signal representing the communication data using a second core with a greater delay than the first core, and a receiver which individually receives the optical signals representing the cryptographic key and the communication data output from the individual cores of the optical transmission path and demodulates the received communication data on the basis of the received cryptographic key information.

### TECHNICAL FIELD

The present disclosure relates to an optical transmission system and an optical transmission method.

### BACKGROUND ART

It has been known to deliver a cryptographic key necessary for demodulation of communication data using a general-purpose single core optical fiber transmission path as an optical transmission system which makes it difficult for a malicious third party to intercept information (see, for example, NPL 1).

However, the general-purpose optical fiber has minute light leakage at local bends. Therefore, in a conventional optical transmission system using the general-purpose single-core optical fiber transmission path, there is a risk that a malicious third party can extract a cryptographic key and communication data without being detected between the communicating parties.

By separating the single-core optical fibers transmit the cryptographic key and communication data, the risk of information leakage due to the signal light extraction can be reduced. However, there has been a problem of complicated synchronization between a cryptographic key and communication data between transmission paths using a plurality of single-core optical fibers due to the different transmission path lengths, and loss of the risk reducing effect due to signal light extracted from the plurality of single-core optical fibers simultaneously.

### CITATION LIST

### Non Patent Literature

[NPL 1] C. E. Shannon, “Communication Theory of Secrecy Systems,” Bell Sys. Tech. J., vol. 28, Issue 4, pp. 656-715 (1949)

### SUMMARY OF THE INVENTION

### Technical Problem

It is an object of the present disclosure to reduce the risk of information exploitation by a malicious third party while allowing communication data to be demodulated in real time.

### Means for Solving the Problem

In an optical transmission system using cryptographic key distribution according to the present disclosure, using a heterogeneous multi-core optical fiber transmission path having two cores with different delays, an optical signal representing a cryptographic key is transmitted using a low-latency core with a smaller delay between the two cores, and an optical signal representing communication data is transmitted using a non-low-latency core with a greater delay.

Specifically, the optical transmission system according to the disclosure includes a transmitter which transmits an optical signal representing a cryptographic key and an optical signal representing communication data individually, an optical transmission path including a heterogeneous multi-core optical fiber having multiple cores, at least one of which has a different propagation delay time, the optical transmission path transmitting the optical signal representing the cryptographic key using a first core with a smaller delay among the multiple cores and the optical signal representing the communication data using a second core with a greater delay than the first core, and a receiver which receives the optical signals representing the cryptographic key and the communication data output from the individual cores of the optical transmission path individually and demodulates the received communication data on the basis of the received cryptographic key information.

Specifically, an optical transmission method according to the disclosure includes transmitting an optical signal representing a cryptographic key and an optical signal representing communication data individually by a transmitter, transmitting, by an optical transmission path including a heterogeneous multi-core optical fiber having multiple cores, at least one of which has a different propagation delay time, the optical signal representing the cryptographic key using a first core with a smaller delay among the multiple cores and the optical signal representing the communication data using a second core with a greater delay than the first core, and individually receiving the optical signals representing the cryptographic key and the communication data output from the individual cores of the optical transmission path and demodulating the received communication data on the basis of the received cryptographic key information by the receiver.

### Effects of the Invention

According to the present disclosure, the risk of information exploitation by a malicious third party can be reduced while allowing communication data to be demodulated in real time.

### BRIEF DESCRIPTION OF DRAWINGS

FIG. 1 is a diagram for illustrating the concept of an optical transmission system using a heterogeneous multi-core optical fiber transmission path according to the present invention.

FIG. 2 is a schematic view for illustrating an exemplary configuration of a heterogeneous multi-core optical fiber according to the present invention.

FIG. 3 illustrates an example of the refractive index of a heterogeneous multi-core optical fiber according to an embodiment of the present invention.

### DESCRIPTION OF EMBODIMENTS

An embodiment of the disclosure will be described in detail with reference to the drawings. The present disclosure is not limited by the following description of the embodiment. These examples are merely illustrative, and the present disclosure can be carried out in various modified and improved forms on the basis of the knowledge of those skilled in the art. In the description and the drawings, elements designated by the same reference characters indicate identical elements.

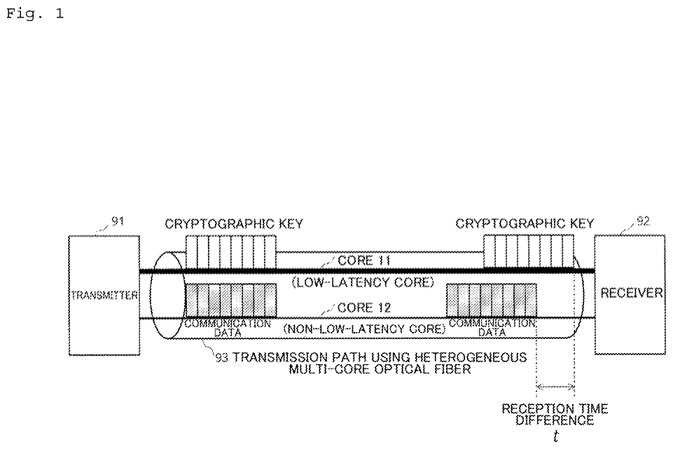

FIG. 1 is a diagram for illustrating the concept of an optical transmission system using a heterogeneous multi-core optical fiber transmission path according to the present invention. The optical transmission system according to the present invention includes a transmitter 91 which transmits optical signals representing a cryptographic key and communication data individually, a transmission path 93 including a heterogeneous multi-core optical fiber which allows the signal light representing the cryptographic key and the communication data to propagate separately through a low-latency core 11 and a non-low-latency core 12, and a receiver 92 which receives the cryptographic key and the communication data distributed by the low-latency core 11 and demodulates the communication data distributed by the non-low-latency core 12 on the basis of the received information.

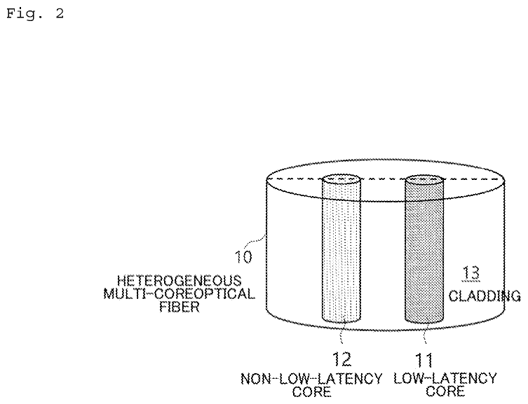

FIG. 2 illustrates an exemplary configuration of a heterogeneous multi-core optical fiber according to the embodiment. The heterogeneous multi-core optical fiber 10 according to the embodiment has a common cladding 13 with a uniform refractive index n₀ and at least one non-low-latency core 12 with a refractive index greater than n₀ and at least one low-latency core 11 in the cladding 13. The low-latency core 11 is a first core and the non-low-latency core 12 is a second core. The non-low-latency core 12 has a greater delay than the low-latency core 11. Here, any existing single-mode optical fiber can be used for the non-low-latency core 12, and the material of the core may English Translation of be pure silica glass or pure silica glass doped with germanium or fluorine.

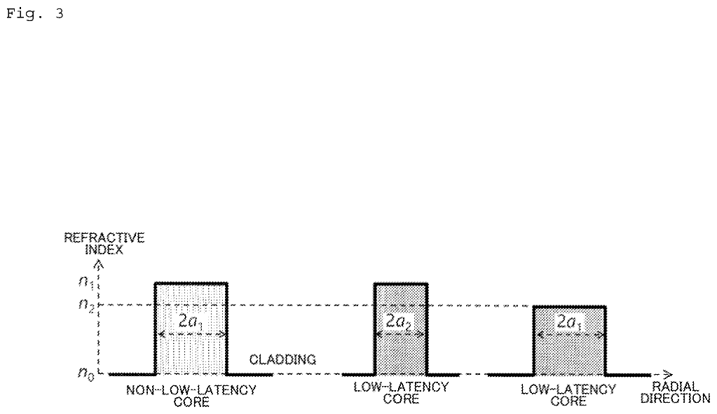

FIG. 3 illustrates an example of the refractive index of the heterogeneous multi-core optical fiber 10. In FIG. 3, for the sake of simplicity, the non-low-latency core 12 has a refractive index n₁ (n₁>n₀) and a diameter 2a₁. At the time, the low-latency core 11 as a part of the heterogeneous multi-core optical fiber 10 according to the embodiment may be realized by setting the diameter or refractive index or both of the low-latency core to a diameter 2a₂ smaller than the diameter of the non-low-latency core 12 (2a₂<2a₁) or a refractive index n₂ lower than the refractive index of the non-low-latency core 12 (n₂<n₁). In the heterogeneous multi-core optical fiber 10 according to the embodiment, crosstalk between adjacent cores must be set sufficiently small. More specifically, the crosstalk at the receiver 92 at the communication wavelength is preferably −18 dB or less.

Here, the heterogeneous multi-core optical fiber 10 according to the embodiment has the function of transmitting a cryptographic key ahead of communication data. Specifically, as shown in FIG. 1, the transmission path 93 according to the disclosure is set such that the cryptographic key and the communication data transmitted simultaneously at the transmitter 91 are received at the receiver 92 with a reception time difference t. For example, the heterogeneous multi-core optical fiber 10 having a length necessary for generating a desired reception time difference t is provided between the transmitter 91 and the receiver 92. As the cryptographic key signal is distributed to the receiver 92 earlier by the reception time difference t, the communication data can be demodulated in real time on the side of the receiver 92 and this eliminates the necessity for providing extra circuits such as a signal buffer, so that the device can be simplified and economized. More specifically, the time difference in the start of receiving between the cryptographic key and the communication data is preferably set to 1 us or more.

As in the foregoing, using the transmission path 93 and the optical transmission system using the heterogeneous multi-core optical fiber 10 according to the embodiment, even if a malicious third party tries to extract an optical signal by adding a bend in the middle of the transmission path, it is difficult to separate individual pieces of information because the cryptographic key and communication data light leak simultaneously from the multiple cores in the heterogeneous multi-core optical fiber 10 while at the same time, crosstalk fluctuations and power fluctuations of the cryptographic key light arriving ahead can be observed on the side of the receiver 92, so that access to the system by the third party can be detected. Furthermore, the cryptographic key transmission using a low-latency core enables real-time demodulation of communication data.

### Effect of the Invention

In an optical transmission system which distributes a cryptographic key, the risk of information exploitation by a malicious third party can be reduced.

In addition, using the heterogeneous multi-core optical fiber 10 including the low-latency core, communication data can be demodulated in real time, so that the receiver 92 can be configured with high simplicity and economy.

### Point of the Invention

The transmission path 93 includes the heterogeneous multi-core optical fiber 10 having the low-latency core 11 and the non-low-latency core 12, and a cryptographic key and communication data are transmitted by the low-latency core 11 and the non-low-latency core 12, respectively, so that the risk of information extraction by a third party is reduced while the communication data can be demodulated in real time.

### INDUSTRIAL APPLICABILITY

The present disclosure is applicable in the information and communications industry.

### REFERENCE SIGNS LIST

10 Heterogeneous multi-core optical fiber
11 Low-latency core
12 Non-low-latency core
13 Cladding
91 Transmitter
92 Receiver
93 Transmission path

1. An optical transmission system, comprising:
a transmitter which transmits an optical signal representing a cryptographic key and an optical signal representing communication data individually;
an optical transmission path including a heterogeneous multi-core optical fiber having multiple cores, at least one of which has a different propagation delay time, the optical transmission path transmitting the optical signal representing the cryptographic key using a first core with a smaller delay among the multiple cores and the optical signal representing the communication data using a second core with a greater delay than the first core; and
a receiver which receives the optical signals representing the cryptographic key and the communication data output from the individual cores of the optical transmission path individually and demodulates the received communication data on the basis of the received cryptographic key information.

2. The optical transmission system according to claim 1, wherein
when the second core has a refractive index n₁ (where n₁>n₀) and a diameter 2a₁, the first core has a refractive index n₂ and a core diameter 2a₂ which are set so that at least one of n₀<n₂≤n₁ and 2a₂≤2a₁ is established (provided that n₂=n₁ and 2a₂=2a₁ are not included).

3. The optical transmission system according to claim 1, wherein the receiver receives the cryptographic key and the communication data with a time difference t of 1 μs or more.

4. The optical transmission system according to claim 1, wherein crosstalk between the first core and the second core at the signal optical wavelength at an end connection with the receiver is −18 dB or less.

5. An optical transmission method comprising the step of:
transmitting an optical signal representing a cryptographic key and an optical signal representing communication data individually by a transmitter;
transmitting, by an optical transmission path including a heterogeneous multi-core optical fiber having multiple cores, at least one of which has a different propagation delay time, the optical signal representing the cryptographic key using a first core with a smaller delay among the multiple cores and the optical signal representing the communication data using a second core with a greater delay than the first core; and
individually receiving the optical signals representing the cryptographic key and the communication data output from the individual cores of the optical transmission path and demodulating the received communication data on the basis of the received cryptographic key information by the receiver.
